(19) United States
(12) Patent Application Publication
(10) Pub. No.: US 2017/0269805 A1
(43) Pub. Date: Sep. 21, 2017

(54) FILE WORKFLOW BOARD

(71) Applicant: Microsoft Technology Licensing, LLC, Redmond, WA (US)

(72) Inventors: John L. DeMaris, Seattle, WA (US); Michael Scott Pierce, Seattle, WA (US); M. Tyler J. Rasmussen, Maple Valley, WA (US)

(21) Appl. No.: 15/073,556

(22) Filed: Mar. 17, 2016

(51) Int. Cl. G06F 3/0486; H04L 29/06; H04L 29/08; G06F 17/30

(52) U.S. Cl. CPC G06F 3/0486; G06F 17/30557; H04L 65/403; H04L 67/10

(57) ABSTRACT

Aspects of the present disclosure relate to systems and methods for creating and progressing files through a workflow using a workflow board. In one aspect, a file repository may be rendered within a file sharing tool. The file repository may include at least a workflow board. A workflow board view associated with a workflow comprising one or more stages may be generated. The generated workflow board view may be displayed as the workflow board. In one example, the workflow board view includes a visual representation of a file status of one or more files progressing through the one or more stages of the workflow.

### BACKGROUND

Workflows may facilitate the management process around business documents. For example, workflows are commonly used to drive processes and manage the lifecycle around files in a document repository. Existing user interface patterns for workflows are form-based and require that a user interact with a form to initiate workflows, progress files through workflows (e.g., change the status of the files), and view the status of files as they progress through workflows. In one example, a user is required to view the metadata on the file itself to identify the workflow status of the file. As such, it may be challenging for users to create and/or utilize existing workflows, ultimately leading to a lack of participation in the use of workflows. In turn, existing tools for creating, building, and/or utilizing workflows may be hard to use, time-consuming and inefficient.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In summary, the disclosure generally relates to systems and methods for creating, building and/or utilizing workflows. In one aspect, a file repository may be rendered within a file sharing tool. The file repository may include at least a workflow board. In response to receiving an input corresponding to the workflow board, a workflow board view may be displayed as the workflow board within the file repository. The workflow board view may comprise a first column including at least one file and a workflow stage control. In response to receiving an input corresponding to the first column, a first stage of the workflow may be created.

In another aspect, a method for progressing one or more files through a workflow is presented. A workflow board view may be displayed within a file repository. The workflow board view may comprise at least a first column and a second column. In one example, the first column includes at least one file. In response to receiving a drag and drop gesture corresponding to the at least one file, the at least one file may be moved from the first column to the second column. In response to moving the at least one file from the first column to the second column, a first file status of the at least one file may be changed to a second file status of the at least one file.

In yet another aspect, rendering of a file repository within a file sharing tool may be initiated. The file repository may include at least a workflow board. A workflow board view associated with a workflow comprising one or more stages may be generated. The generated workflow board view may be displayed as the workflow board. In some examples, the workflow board view comprises a visual representation of a file status of one or more files progressing through the one or more stages of the workflow.

### DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 illustrates an exemplary workflow system for creating, building, and utilizing a workflow, according to an example aspect.

FIG. 2 illustrates an example file sharing tool for building, creating, and/or utilizing a workflow, according to an example aspect.

FIG. 3A illustrates one view in a progression of views of a file sharing tool, according to an example aspect.

FIG. 3B illustrates another view in the progression of views of the file sharing tool of FIG. 3A, according to an example aspect.

FIG. 4 illustrates an exemplary method for creating a workflow, according to an example aspect.

FIG. 5 illustrates an exemplary method for progressing one or more files through a workflow, according to an example aspect.

FIG. 6 illustrates a computing system suitable for implementing the enhanced workflow technology disclosed herein, including any of the environments, architectures, elements, processes, user interfaces, and operational scenarios and sequences illustrated in the Figures and discussed below in the Technical Disclosure.

### DETAILED DESCRIPTION

Aspects of the disclosure are generally directed to creating workflows and progressing files through a workflow using a workflow board. For example, a workflow may be created by building stages of the workflow using the workflow board. In another example, files associated with a workflow may be progressed through the workflow using simple drag and drop gestures via a workflow board. In yet another example, a workflow may be built using existing techniques and/or tools for building workflows while also including a visual representation of the files progressing through the workflow using a workflow board. In some cases, a workflow board view may be generated and displayed as the workflow board. The workflow board view may change and/or be updated as a workflow is created and/or as files are progressing through a workflow. In one example, the workflow board view may include one or more columns, where each column of the one or more columns represents a stage of the workflow. Each stage of the workflow may represent a file status. For example, one stage of the workflow may include “Approved.” In this example, a file located in the “Approved” column may have a file status of “Approved.” As such, a user of the workflow may easily and quickly identify the status of a file progressing through the workflow by merely visually locating the file in a stage/column of the workflow board view.

As discussed above, existing user interface patterns for workflows are form-based and require that a user interact with a form to initiate workflows, progress files through workflows (e.g., change the status of the files), and view the status of files as they progress through workflows. As such, it may be challenging for users to create and/or utilize existing workflows, ultimately leading to a lack of participation in the use of workflows. In turn, existing tools for creating, building, and/or utilizing workflows may be hard to use, time-consuming and inefficient.

Accordingly, aspects described herein includes tools and/or techniques that make creating, building, and/or utilizing workflows intuitive, user-friendly, and efficient. In one aspect, a file repository may be rendered within a file sharing tool (e.g., SharePoint, OneDrive). The file repository may include one or more files associated with a workflow. The file repository may further include at least a workflow board. In this regard, a user of the file repository may create a workflow using the workflow board. In one case, in response to receiving an input corresponding to the workflow board, a workflow board view may be displayed as the workflow board within the file repository. In one example, the input received may include a drag and drop gesture corresponding to the workflow board. For example, a user may drag a file from a location within the file repository to the workflow board. When the file is dropped within the workflow board, a workflow board view including a first column having the file may be displayed as the workflow board within the file repository. The first column may represent a first stage of the workflow. In response to receiving an input corresponding to the first column (e.g., a user may define the first stage of the workflow using a keyboard input), the first stage of the workflow may be created. In some examples, the workflow board view includes a workflow stage control. In response to receiving a selection of the workflow stage control, the workflow board view displayed as the workflow board may be updated to display a another column (e.g., a second column). In this regard, a user may select the workflow stage control to create additional columns/stages of the workflow. As such, a technical effect that may be appreciated is that the tools and/or techniques disclosed herein provide a compelling visual and functional experience for users to create and/or build workflows intuitively and efficiently through interaction with a user interface.

In another aspect, a workflow board view may be displayed within a file repository. The workflow board view may facilitate progressing files through a workflow. For example, the workflow board view may include one or more columns, where the one or more columns include one or more files. The one or more columns of the workflow board view may represent one or more stages that represent one or more file statuses. When one of the files is moved (e.g., via a drag and drop gesture) from a first column to a second column, the file status of the file that is moved may be changed from a first file status to a second file status. In some cases, in response to moving a file from the first column to the second column, the workflow is initiated. As one or more files are moved through the workflow (e.g., via a drag and drop gesture), the workflow board view may be updated to reflect the current statuses of the files progressing through the workflow. In this regard, another technical effect that may be appreciated is that the tools and/or techniques disclosed herein provide a compelling visual and functional experience for users to utilize workflows (e.g., progress files through a workflow) intuitively and efficiently through interaction with a user interface. A further technical effect that may be appreciated is that building, creating, and utilizing workflows is improved by providing a visual representation of the files (including file status) progressing through the workflow using a workflow board, ultimately saving time and reducing processor load and conserving memory.

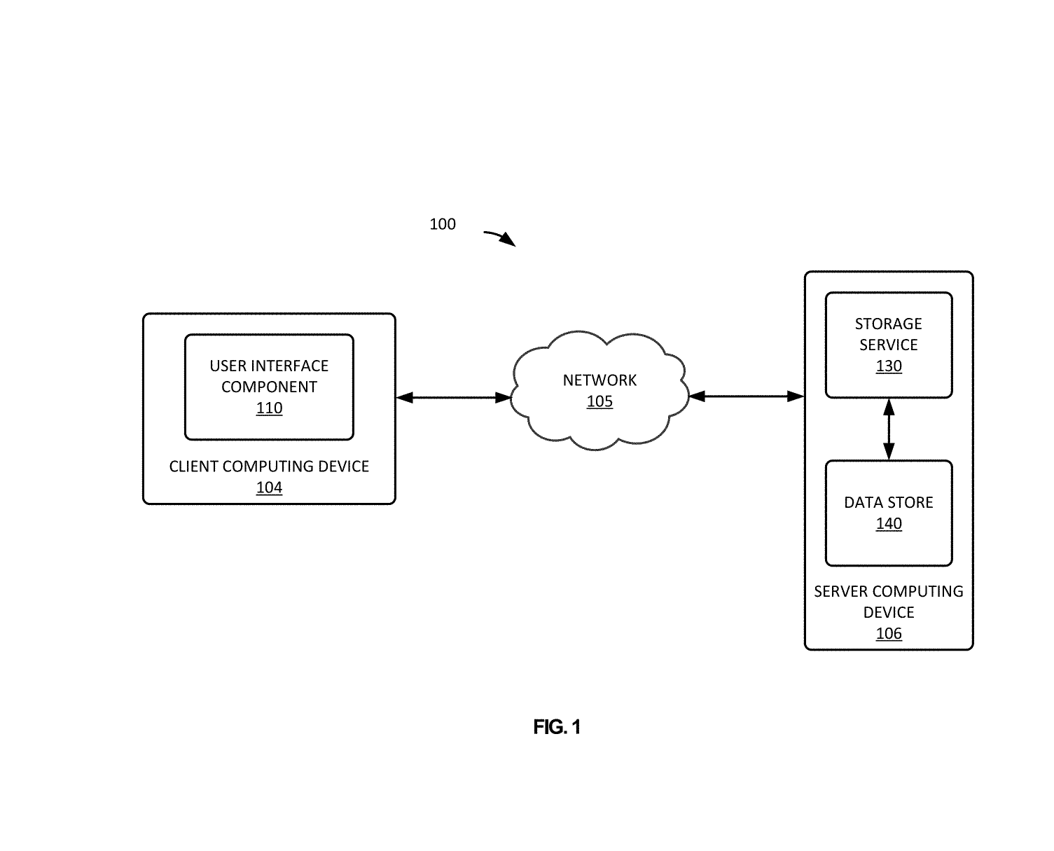

Referring now to the drawings, in which like numerals represent like elements through the several figures, aspects of the present disclosure and the exemplary operating environment will be described. With reference to FIG. 1, one aspect of a workflow system 100 for creating, building and/or utilizing workflows is illustrated. In aspects, the workflow system 100 may be implemented on a client computing device 104. In a basic configuration, the client computing device 104 is a handheld computer having both input elements and output elements. The client computing device 104 may be any suitable computing device for implementing the workflow system 100 for creating, building, and/or utilizing a workflow. For example, the client computing device 104 may be at least one of: a mobile telephone; a smart phone; a tablet; a phablet; a smart watch; a wearable computer; a personal computer; a desktop computer; a laptop computer; a gaming device/computer (e.g., Xbox); a television; and etc. This list is exemplary only and should not be considered as limiting. Any suitable client computing device 104 for implementing the workflow system 100 for creating, building, and/or utilizing a workflow may be utilized.

In aspects, the workflow system 100 may be implemented on a server computing device 106. The server computing device 106 may provide data to and from the client computing device 104 through a network 105. In aspects, the workflow system 100 may be implemented on more than one server computing device 106, such as a plurality of server computing devices 106. As discussed above, the server computing device 106 may provide data to and from the client computing device 104 through the network 105. The data may be communicated over any network suitable to transmit data. In some aspects, the network is a distributed computer network such as the Internet. In this regard, the network may include a Local Area Network (LAN), a Wide Area Network (WAN), the Internet, wireless and wired transmission mediums. In this regard, a workflow board may be created for display on a user interface of the client computing device 104.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an Intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which aspects of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

As illustrated in FIG. 1, the client computing device 104 may include a user interface component 110 and the server computing device 106 may include a storage service 130, and a data store 140. The various components may be implemented using hardware, software, or a combination of hardware and software. The workflow system 100 may be configured to generate a workflow board associated with a workflow for display on a user interface of the client computing device 104. In this regard, the user interface component 110 may be configured to display a workflow board and/or a workflow board view associated with a workflow. In one aspect, the user interface component 110 may render a file repository within a file sharing tool. The file repository may include any repository associated with a workflow. For example, as discussed above, workflows are commonly used to drive processes and manage the lifecycle around files in a file repository. In this regard, the file repository may include one or more files for progressing through a workflow. In one case, the one or more files may be associated with an application. In one example, an application may include any application suitable for collaboration and/or co-authoring such as a word processing application, spreadsheet application, electronic slide presentation application, email application, chat application, voice application, and the like. In one case, a file associated with the application may include a word document, a spreadsheet, an electronic slide presentation, an email, a chat conversation, and the like. As such, an exemplary application may be an electronic slide presentation application. In this example, an exemplary file associated with the electronic slide presentation application may include an electronic slide presentation.

In some examples, the file sharing tool may include any file sharing tool suitable for processing and/or managing files associated with an application. In one case, the file sharing tool may facilitate collaboration and/or co-authoring of files. For example, the file sharing tool may include a service such as OneDrive, SharePoint, Dropbox, and the like. In some examples, the file repository rendered within the file sharing tool may include a workflow board. The workflow board may include any board associated with a workflow and suitable for providing a visual representation of files progressing through a workflow. In one example, the workflow is built and/or created using existing workflow tools such as SharePoint Designer and Nintex Workflow designer. In order to initiate a workflow, progress files through a workflow, and/or identify a file status of a file associated with the workflow using these existing workflow tools, a user is required to interact with a form and/or view the metadata on the file itself to identify the file status. In this regard, the workflow board of the present disclosure may provide a visual representation of files progressing through a workflow that is built and/or created using existing workflow tools.

In one example, a workflow board view associated with the workflow may be generated. The workflow board view may provide a visual representation of one or more stages of the workflow and/or one or more files associated with the workflow. In this regard, a workflow that has been built and/or created using existing workflow tools, such as those described herein, may be represented visually. In another aspect, the user interface component 110 may display the generated workflow board view as the workflow board. In one case, the generated workflow board view may include a plurality of columns. The plurality of columns may represent one or more stages of the workflow. In one example, if a workflow includes four stages, the workflow board view may include four columns. The one or more stages of the workflow may represent a file status of the one or more files progressing through the one or more stages of the workflow.

Using the example described above, the first column/stage of the workflow may have a status of “Not Started.” In this regard, a file located in the “Not Started” column/stage may have a file status of “Not Started.” The second column/stage of the workflow may have a status of “Ready for Review.” In this regard, a file located in the “Ready for Review” column/stage may have a file status of “Ready for Review.” The third column/stage of the workflow may have a status of “Approved.” In this regard, a file located in the “Approved” column/stage may have a file status of “Approved.” The fourth column/stage of the workflow may have a status of “Done.” In this regard, a file located in the “Done” column/stage may have a file status of “Done.” As such, while the workflow stages may be built using existing workflow tools, the workflow board view may provide a visual representation of the one or more stages of the workflow and/or the one or more files associated with the workflow, ultimately improving the visual and functional experience for end-users of workflows. Furthermore, by using workflows created by and/or built by the existing workflow tools, administrators of the workflows may continue to use the workflow tools and/or techniques familiar to them. It is appreciated that while specific examples for a workflow board and/or workflow board view are described herein, the discussion of the workflow board and/or workflow board view is exemplary only and should not be considered as limiting. Any number of columns, stages, and/or files may be included in a workflow and/or visually represented by a workflow board and/or workflow board view.

In one example, the user interface component 110 may be a touchable user interface that is capable of receiving input via contact with a screen of the client computing device 104, thereby functioning as both an input device and an output device. For example, content may be displayed, or output, on the screen of the client computing device 104 and input may be received by contacting the screen using a stylus or by direct physical contact of a user, e.g., touching the screen. Contact may include, for instance, tapping the screen, using gestures such as swiping or pinching the screen, sketching on the screen, etc.

In another example, the user interface component 110 may be a non-touch user interface. In one case, a tablet device, for example, may be utilized as a non-touch device when it is docked at a docking station (e.g., the tablet device may include a non-touch user interface). In another case, a desktop computer may include a non-touch user interface. In this example, the non-touchable user interface may be capable of receiving input via contact with a screen of the client computing device 104, thereby functioning as both an input device and an output device. For example, content may be displayed, or output, on the screen of the client computing device 104 and input may be received by contacting the screen using a cursor, for example. In this regard, contact may include, for example, placing a cursor on the non-touchable user interface using a device such as a mouse.

In some aspects, the workflow system 100 is implemented within the storage service 130. In one example, the storage service 130 may be configured to store, manage, and access data and/or information associated with the workflow system 100. For example, the storage service 130 may store one or more files within the file repository in a data store 140. In one example, data store 140 may be part of and/or located at the storage service 130. In another example, data store 140 may be a separate component and/or may be located separate from the storage service 130. It is appreciated that although one server computing device 106 is illustrated in FIG. 1, the workflow system 100 may include a plurality of server computing devices 106 with a plurality of storage services 130 and a plurality of data stores 140. In some cases, the server computing device 106 may include a plurality of storage services 130 and a plurality of data stores 140. For example, the plurality of storage services 130 may include at least file storage providers, external activity services and document editing clients. In one example, the storage service 130 may include a file sharing tool such as OneDrive, SharePoint, Google Drive, Dropbox, and the like.

In some aspects, the file sharing tool, workflow, and/or workflow board may be part of and/or located at the client computing device 104. In other aspects, the file sharing tool, workflow, and/or workflow board may be located at the server computing device 106. In yet other aspects, portions of the file sharing tool, workflow, and/or workflow board may be located at the client computing device 104, and portions of the file sharing tool, workflow, and/or workflow board may be located at the server computing device 106.

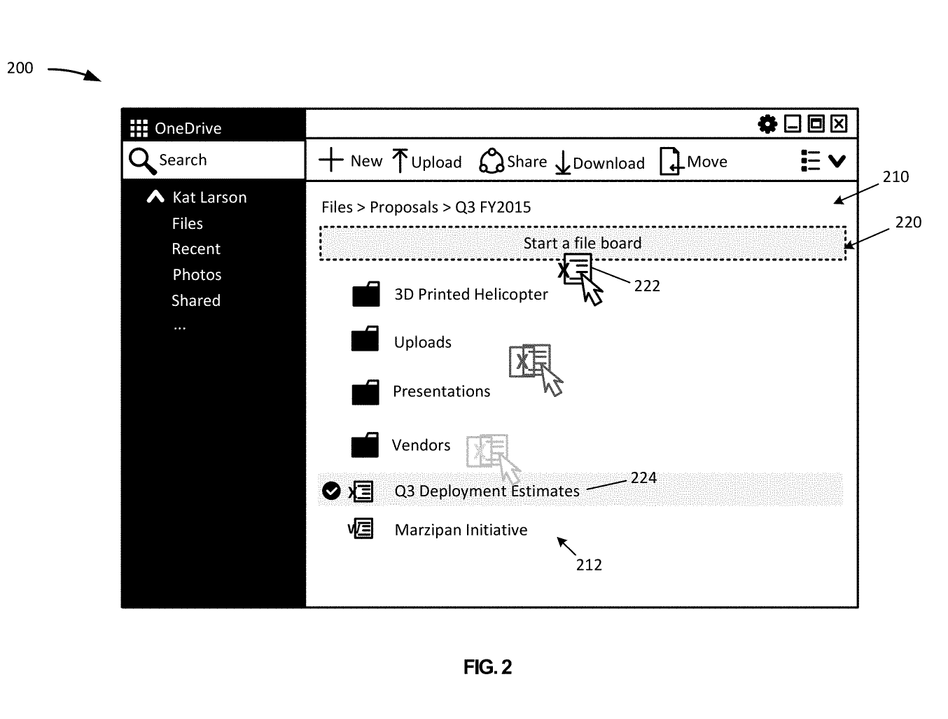

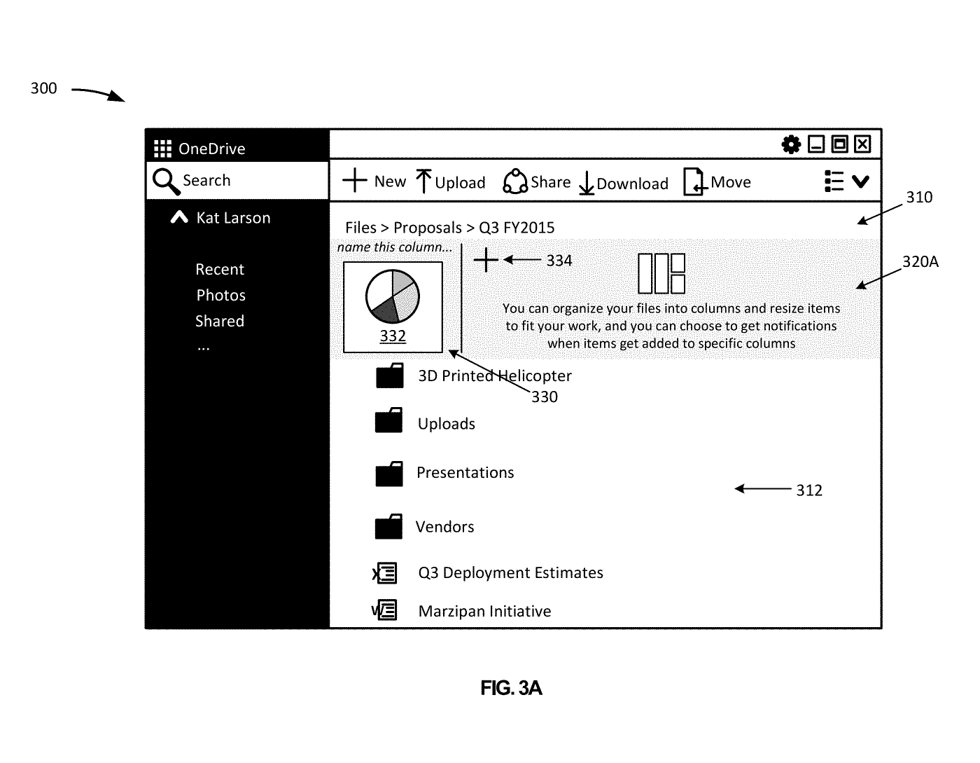

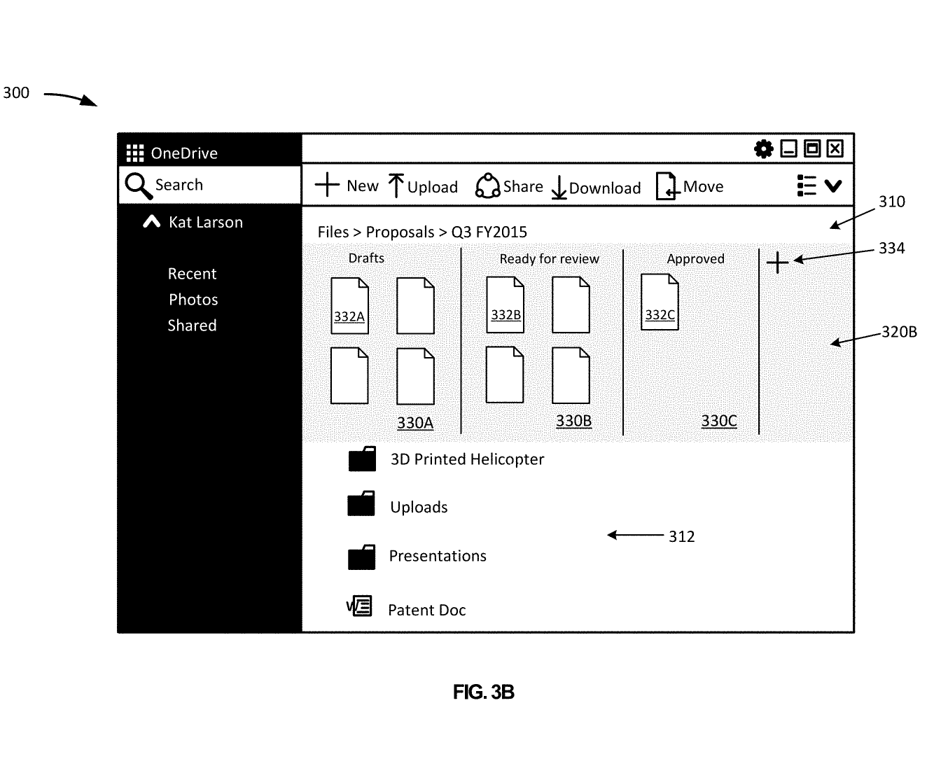

Referring now to FIG. 2, an example file sharing tool 200 for building, creating, and/or utilizing a workflow is shown. The exemplary file sharing tool 200, as shown in FIG. 2, is OneDrive. As discussed above, the file sharing tool 200 may include any file sharing tool suitable for processing and/or managing files associated with an application. In one example, the file sharing tool 200 includes a file repository 210, one or more files 212, and a workflow board 220. As illustrated in FIG. 2, the file repository 210 includes a plurality of folders (e.g., including files) and one or more files 212. The one or more files 212 may include any file associated with an application such as a word document, a spreadsheet, an electronic slide presentation, an email, a chat conversation, and the like. In one example, in response to receiving an input 222 corresponding to the workflow board 220, a workflow board view may be displayed as the workflow board 220 within the file repository 210 (as illustrated in FIGS. 3A and 3B). In one example, the input 222 corresponding to the workflow board 220 may include a drag and drop gesture. For example, a user may drag the file 224 to the workflow board 220 and drop the file 224 within the workflow board 220.

FIG. 3A illustrates one view in a progression of views of a file sharing tool 300 for building, creating, and/or utilizing a workflow, according to an example aspect. Similar to the file sharing tool 200 of FIG. 2, the file sharing tool 300, as illustrated in FIG. 3A, is OneDrive. The file sharing tool 300 may include any file sharing tool suitable for processing and/or managing files associated with an application. In one example, the file sharing tool 300 includes a file repository 310, one or more files 312, and a workflow board view 320A. As illustrated in FIG. 3A, the file repository 310 includes a plurality of folders (e.g., including files) and one or more files 312. The one or more files 312 may include any file associated with an application such as a word document, a spreadsheet, an electronic slide presentation, an email, a chat conversation, and the like. In one example, the workflow board view 320A is displayed as a workflow board within the file repository 310 in response to an input corresponding to the workflow board (e.g., such as the input 222 corresponding to the workflow board 220 described relative to FIG. 2).

In the example illustrated in FIG. 3A, the workflow board view 320A includes a first column 330 including at least one file 332 and a workflow stage control 334. In one example, the at least one file 332 is displayed within the first column 330 in response to dragging and dropping the at least one file 332 into a workflow board (e.g., such as dragging the file 224 to the workflow board 220 described relative to FIG. 2). In another example, the at least one file 332 may be displayed within the first column 330 in response to dragging the at least one file 332 from the file repository 310 to the workflow board view 320A and dropping the at least one file 332 into the first column 330 of the workflow board view 320A. In one example, the workflow stage control 334 may facilitate creating and/or building a workflow associated with the file repository 310. For example, in response to receiving a selection of the workflow stage control 334, the workflow board view 320A displayed as the workflow board may be updated to display a second column (as illustrated in FIG. 3B). When a second column is displayed within the workflow board view 320A (not illustrated), the workflow stage control 334 may be displayed adjacent to the second column (not illustrated). In this regard, in response to receiving another selection of the workflow stage control 334, the workflow board view 320A displayed as the workflow board may be updated to display a third column (as illustrated in FIG. 3B). As such, a workflow may be created and/or built using a workflow board, as described herein. It is appreciated that any number of columns and/or stages may be created for a workflow.

In some aspects, in response to receiving an input corresponding to the first column 330, a first stage of the workflow may be created. In one example, the input corresponding to the first column may include a keyboard input for defining the first stage of the workflow. For example, as illustrated in FIG. 3A, the first column 330 includes the text, “name this column.” A user may define the first stage of the workflow by typing text into the field that includes the text, “name this column.” For example, a user may define the first stage of the workflow as “Not Started,” and replace the text, “name this column,” with the text “Not Started,” via a keyboard input. The first stage of the workflow may represent a file status. For example, if the first stage of the workflow is defined as “Not Started,” the file status of the file 332 is “Not Started.” In this regard, a user may quickly and easily identify the file status of the file 332 as it progresses through the workflow. Furthermore, building and/or creating a workflow, as described relative to FIG. 3A, provides a compelling visual and functional experience for users to create and/or build workflows intuitively and efficiently through interaction with a user interface (e.g., through interaction with the workflow board and/or workflow board view).

FIG. 3B illustrates another view in a progression of views of the file sharing tool 300 for building, creating, and/or utilizing a workflow, according to an example aspect. The file sharing tool 300 includes the file repository 310, one or more files 312, and a workflow board view 320B. In one example, the workflow board view 320B is a visual representation of a workflow that has been created using a workflow board (e.g., the workflow board view 320A as described relative to FIG. 3A). The workflow board view 320B includes a first column 330A including at least one file 332A, a second column 330B including at least one file 332B, a third column 330C including at least one file 332C, and a workflow stage control 334. In one example, the at least one file 332A is displayed within the first column 330A in response to dragging and dropping the at least one file 332A into a workflow board (e.g., such as dragging the file 224 to the workflow board 220 described relative to FIG. 2). In another example, the at least one file 332A may be displayed within the first column 330A in response to dragging the at least one file 332A from the file repository 310 to the workflow board view 320B and dropping the at least one file 332 into the first column 330A of the workflow board view 320B. In one example, the workflow stage control 334 may facilitate creating and/or building a workflow associated with the file repository 310, such as described above relative to FIG. 3A.

As illustrated in FIG. 3B, the first column 330A represents a first stage of the workflow and the first stage of the workflow may represent a first file status. For example, the first stage of the workflow is “Drafts.” In this regard, the first file status is “Drafts.” For purposes of illustration, the at least one file 332A may be the first file and have a first file status of “Drafts.” The first file status may indicate a first status of a file as the file begins progressing through a workflow. The second column 330B represents a second stage of the workflow and the second stage of the workflow may represent a second file status. For example, the second stage of the workflow is “Ready for review.” In this regard, the second file status is “Ready for review.” The second file status may indicate a second status of a file as the file progresses through the workflow. The third column 330C represents a third stage of the workflow and the third stage of the workflow may represent a third file status. For example, the third stage of the workflow is “Approved.” In this regard, the third file status is “Approved.” The third file status may indicate a third status of a file as the file progresses through the workflow.

As described herein, the workflow board and/or workflow board view 320B may facilitate utilizing a workflow. For example, the workflow board view 320 may facilitate progressing files through a workflow. In this regard, in response to receiving an input corresponding to the at least one file 332A, the at least one file 332A may be moved from the first column 330A to the second column 330B. In one example, the input corresponding to the at least one file 332A is a drag and drop gesture. For example, a user may drag the at least one file 332A from the first column 330A to the second column 330B. In one case, in response to moving the at least one file 332A from the first column 330A to the second column 330B, a first file status of the at least one file 332A is changed to a second file status of the at least one file 332A. For example, in response to moving the at least one file 332A from the first column 330A to the second column 330B, the first file status of the at least one file 332A “Drafts” is changed to the second file status of “Ready for review.” In this regard, a user may change the status of a file progressing through a workflow via a simple drag and drop gesture. A second user assigned to reviewing the file may view the workflow board view 320B and quickly and easily identify that the at least one file 332A now has a status of “Ready to review.” When the second user has reviewed the file, the at least one file 332A may be moved from the “Ready to review” stage (e.g., column 330B) of the workflow to the “Approved” stage (e.g., column 330C) of the workflow in response to receiving a simple drag and drop gesture from the second user. In this regard, in response to moving the at least one file 332A from the second column 330B to the third column 330C, the workflow may be progressed by changing the second file status (e.g., “Ready to review”) of the at least one file 332A to a third file status “Approved”. In one example, when the status of a file changes in response to moving a file from one column to an adjacent column, the workflow board view 320B may be updated to display the changed file status.

In some cases, in response to moving the at least one file 332A from the first column 330A to the second column 330B, the workflow may be initiated. For example, in some cases, the first column and/or stage of a workflow may be “Not Started.” In this case, the workflow may be initiated when a file in the “Not Started” stage is moved to the adjacent column (e.g., the second column/stage of the workflow). A workflow may be initiated by executing the pre-created Workflow programming code (e.g., the programming code of the existing Workflow tools described herein). In one example, the workflow may be completed in response to moving a file to a final column/stage of the workflow. For example, the final column/stage of a workflow may have a defined status of “Done.” In this regard, in the example illustrated in FIG. 3B, when the at least one file 332A, 332B, and/or 332C is moved to a final column (e.g., in response to receiving a drag and drop gesture) the at least one file 332A, 332B, and/or 332C has completed the workflow and has a file status of “Done” (not illustrated).

In some examples, when the status of the at least one file 332A changes in response to moving the at least one file 332A from one column (e.g., 330A) to an adjacent column (e.g., 330B), a notification may be generated. For example, a generated notification may be sent via email to a user of the workflow. In one example, when a user is assigned to reviewing a file, a generated notification may be sent to the user assigned to reviewing a file when the file is moved to the “Ready to review” stage of the workflow. In some cases, more than one user may create one or more stages within a workflow. For example, a first user of the workflow may create a “Not Started” stage and a “Ready for review” stage. A second user of the workflow assigned to the “Ready for review” stage for a file, may create a third stage after reviewing the file. For example, the second user may review a file with a “Ready for review” file status and create a third stage “Approved”. After creating the “Approved” stage, the file may be moved from the “Ready to review” stage to the “Approved” stage in response to a drag and drop gesture, for example, by the second user.

In some cases, in response to receiving a drag and drop gesture corresponding to at least one file, a prerequisite check may be performed. For example, the prerequisite check may verify whether a user has permissions to move a file from a one stage to a next stage. In one example, a first user may create a file and second user may be assigned to review and approve the file. In this example, when the first user attempts to move the file from a “Draft” stage to a “Ready to review” stage, the prerequisite check may be performed. In this case, it may be verified that the first user has permissions to move the file from the Draft” stage to the “Ready to review” stage. If the first user attempts to move the file from the “Ready to review” stage to the “Approved” stage, it may be determined that the first user does not have permissions to move the file from the “Ready to review” stage to the “Approved” stage. In this regard, the file may not be moved from the “Ready to review” stage to the “Approved” stage. When the second user attempts to move the file from the “Ready to review” stage to the “Approved” stage, it may be determined that the second user does have permissions to move the file from the “Ready to review” stage to the “Approved” stage.

While the present disclosure discusses file sharing tools 200, 300, file repositories 210, 310, one or more files 212, 312, workflow board 220, workflow board views 320A, 320B, columns 330, 300A, 330B, 330C, files 332, 332A, 332B, 332C, and various types of stages and/or file statuses of a workflow, this is only exemplary and should not be considered limiting. Any number of file sharing tools, file repositories, files, workflow boards, workflow board views, columns, stages, and file statuses of a workflow may be utilized in conjunction with the present disclosure.

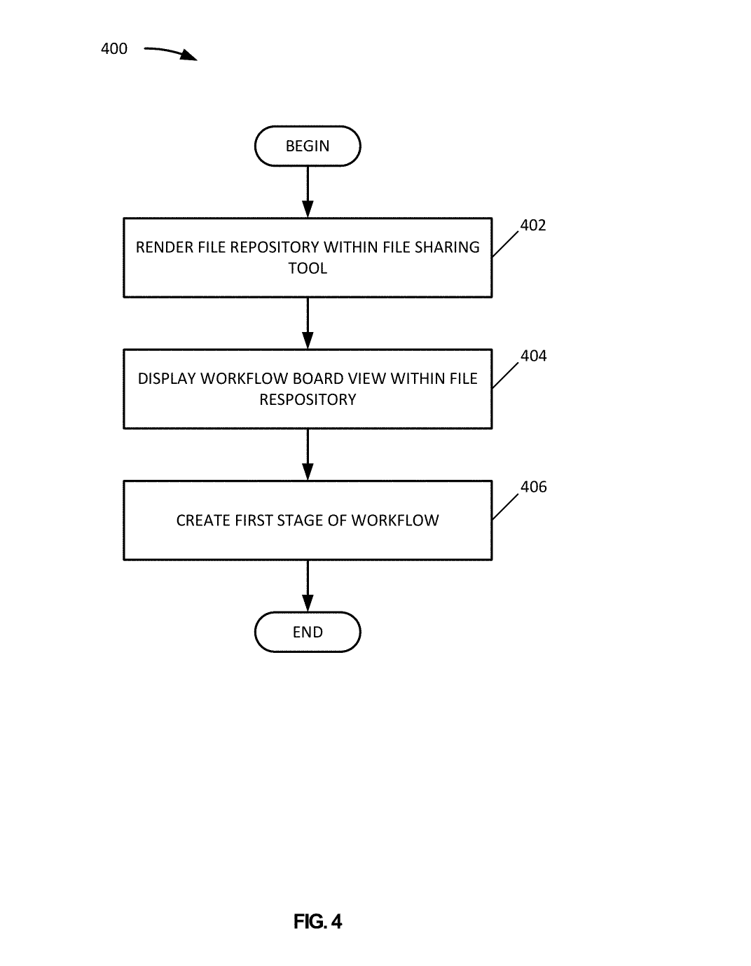

Referring now to FIG. 4, an exemplary method 400 for creating a workflow, according to an example aspect is shown. Method 400 may be implemented on a computing device or a similar electronic device capable of executing instructions through at least one processor. Method 400 may begin at operation 402, where a file repository may be rendered within a file sharing tool. In one example, the file repository includes at least a workflow board. The file repository may include any repository associated with a workflow. For example, as discussed above, workflows are commonly used to drive processes and manage the lifecycle around files in a file repository. In this regard, the file repository may include one or more files for progressing through a workflow. In some examples, the file sharing tool may include any file sharing tool suitable for processing and/or managing files associated with an application. In one case, the file sharing tool may facilitate collaboration and/or co-authoring of files. For example, the file sharing tool may include a service such as OneDrive, SharePoint, Dropbox, and the like. In some examples, the file repository rendered within the file sharing tool may include a workflow board. The workflow board may include any board associated with a workflow and suitable for providing a visual representation of files progressing through a workflow.

When a file repository is rendered within a file sharing tool, flow proceeds to operation 404 where a workflow board view is displayed as a workflow board within the file repository in response to receiving an input corresponding to the workflow board. In one example, the received input corresponding to the workflow board may include a drag and drop gesture corresponding to the workflow board. For example, a user may drag a file from a location within the file repository to the workflow board. When the file is dropped within the workflow board, the workflow board view may be displayed as the workflow board within the file repository. In one example, the workflow board view may include at least a first column. The first column may represent a first stage of the workflow. The first stage of the workflow may represent a file status. The workflow board view may provide a visual representation of one or more stages of the workflow and/or one or more files associated with the workflow.

When the workflow board view is displayed as the workflow board within the file repository, flow proceeds to operation 406, where a first stage of the workflow is created in response to receiving an input corresponding to the first column of the workflow board view. In one example, the input corresponding to the first column may include a keyboard input for defining the first stage of the workflow. In some examples, the workflow board view includes a workflow stage control. In response to receiving a selection of the workflow stage control, the workflow board view displayed as the workflow board may be updated to display a another column (e.g., a second column). In this regard, a user may select the workflow stage control to create additional columns/stages of the workflow. As such, the workflow board provides a compelling visual and functional experience for users to create and/or build workflows intuitively and efficiently through interaction with a user interface (e.g., the workflow board and/or workflow board view).

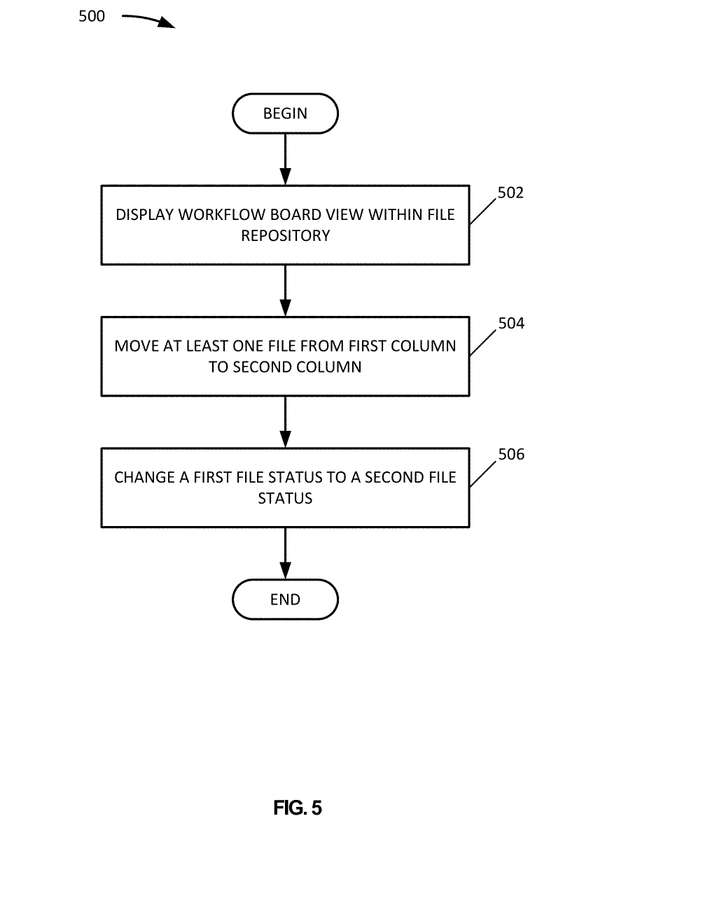

Referring now to FIG. 5, an exemplary method 500 for progressing one or more files through a workflow, according to an example aspect is shown. Method 500 may be implemented on a computing device or a similar electronic device capable of executing instructions through at least one processor. Method 500 begins at operation 502 where a workflow board view is displayed within a file repository. The workflow board view displayed within the file repository may include at least a first column and a second column. The first column may include at least one file. The first column may represent a first stage of the workflow and the first stage of the workflow may represent a first file status. The second column may represent a second stage of the workflow and the second stage of the workflow may represent a second file status. In some examples, the workflow board view may include a third column. The third column may represent a third stage of the workflow and the third stage of the workflow may represent a third file status. The workflow board view may further include a final column. In one example, in response to moving the at least one file to the final column, the workflow may be completed.

At operation 504, in response to receiving a drag and drop gesture corresponding to the at least one file, the at least one file is moved from the first column to the second column. In some cases, in response to receiving a drag and drop gesture corresponding to at least one file, a prerequisite check may be performed. For example, the prerequisite check may determine whether a user has permissions to move a file from a one stage to a next stage. In one example, when it is determined that the user has permissions to move the file from the one stage to the next stage, the at least one file is moved from the first column to the second column. In another example, when it is determined that the user does not have permissions to move the file from the one stage to the next stage, the file may not be moved from the first column to the second column.

At operation 506, in response to moving the at least one file from the first column to the second column, a first file status of the at least one file is changed to a second file status of the at least one file. For example, the first column may define the first file status as “Drafts” and the second column may define the second file status as “Review.” In this regard, when the at least one file is moved from “Drafts” to “Review” the file status of the at least one file is changed from “Drafts” to “Review.” In some examples, in response to moving the at least one file from the first column to the second column, a notification is generated. For example, a generated notification may be sent via email to a user of the workflow. In one example, when a user is assigned to reviewing a file, a generated notification may be sent to the user assigned to reviewing a file when the file is moved to the “Ready to review” stage of the workflow.

The term rendering as used herein generally refers to the various capabilities employed in various computing architectures to assemble information that can then be used by other capabilities to generate an image or images. Within the context of method 400, for example, rendering a file repository, for example, generally refers to assembling the information or data used to generate an image or images that together result in the file repository. Animation or other dynamics may also be used to achieve certain effects.

However, it may be appreciated that other perspectives on rendering may be considered within the scope of the present disclosure. For example, rendering as used herein may also, in some scenarios, be considered to refer to the various capabilities employed by various computing architectures to generate an image or images from information assembled for that purpose. With respect to the method 400, rendering a file repository may refer to generating an image or images, from information assembled for that purpose, that together result in the file repository, which can then be displayed.

It may also be appreciated that rendering in some scenarios may refer to a combination of the aforementioned possibilities. For example, rendering in some scenarios may refer to both assembling the information used to generate an image or images for a file repository and then generating the image or images of the file repository. In addition, a wide variety of other steps, processes, and stages may occur within the context of presenting views of an application, all of which may be considered part of presenting a view. Thus, yet one other variation on method 400 includes, but is not limited to, presenting a file repository, presenting a workflow board view, and creating a first stage of a workflow.

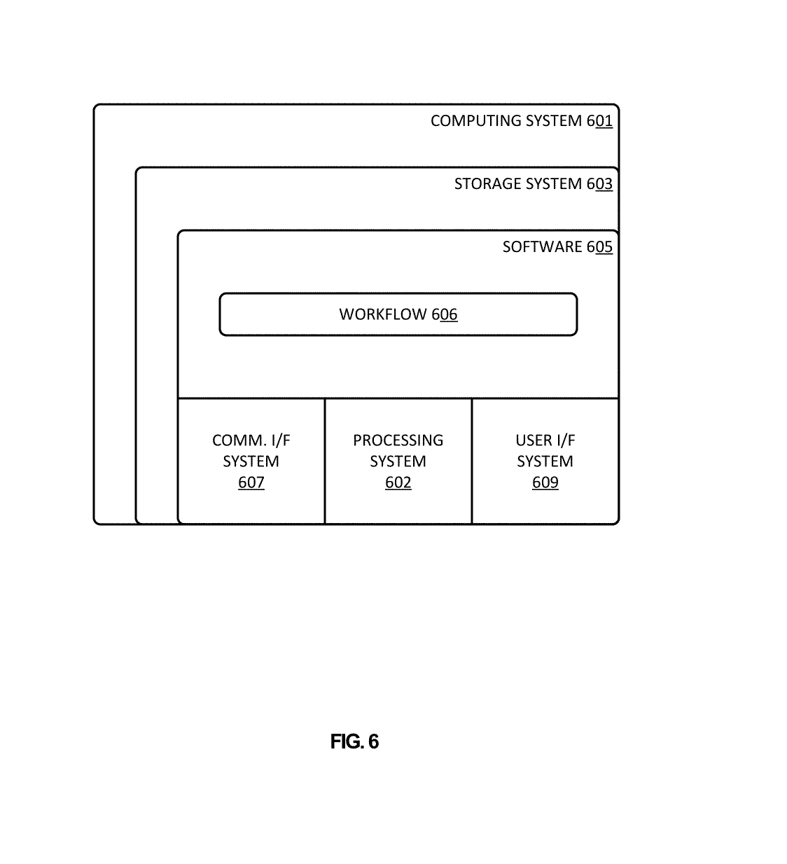

FIG. 6 illustrates computing system 601 that is representative of any system or collection of systems in which the various applications, services, scenarios, and processes disclosed herein may be implemented. Examples of computing system 601 include, but are not limited to, server computers, rack servers, web servers, cloud computing platforms, and data center equipment, as well as any other type of physical or virtual server machine, container, and any variation or combination thereof. Other examples may include smart phones, laptop computers, tablet computers, desktop computers, hybrid computers, gaming machines, virtual reality devices, smart televisions, smart watches and other wearable devices, as well as any variation or combination thereof.

Computing system 601 may be implemented as a single apparatus, system, or device or may be implemented in a distributed manner as multiple apparatuses, systems, or devices. Computing system 601 includes, but is not limited to, processing system 602, storage system 603, software 605, communication interface system 607, and user interface system 609. Processing system 602 is operatively coupled with storage system 603, communication interface system 607, and user interface system 609.

Processing system 602 loads and executes software 605 from storage system 603. Software 605 includes workflow 606, which is representative of the workflows discussed with respect to the preceding FIGS. 1-5, including the workflow boards and/or workflow board views described herein. When executed by processing system 602 to enhance workflows, software 605 directs processing system 602 to operate as described herein for at least the various processes, operational scenarios, and sequences discussed in the foregoing implementations. Computing system 601 may optionally include additional devices, features, or functionality not discussed for purposes of brevity.

Referring still to FIG. 6, processing system 602 may comprise a micro-processor and other circuitry that retrieves and executes software 605 from storage system 603. Processing system 602 may be implemented within a single processing device, but may also be distributed across multiple processing devices or sub-systems that cooperate in executing program instructions. Examples of processing system 602 include general purpose central processing units, application specific processors, and logic devices, as well as any other type of processing device, combinations, or variations thereof.

Storage system 603 may comprise any computer readable storage media readable by processing system 602 and capable of storing software 605. Storage system 603 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 603 may also include computer readable communication media over which at least some of software 605 may be communicated internally or externally. Storage system 603 may be implemented as a single storage device, but may also be implemented across multiple storage devices or sub-systems co-located or distributed relative to each other. Storage system 603 may comprise additional elements, such as a controller, capable of communicating with processing system 602 or possibly other systems.

Software 605 may be implemented in program instructions and among other functions may, when executed by processing system 602, direct processing system 602 to operate as described with respect to the various operational scenarios, sequences, and processes illustrated herein. For example, software 605 may include program instructions for implementing enhanced workflows.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 605 may include additional processes, programs, or components, such as operating system software, virtual machine software, or other application software, in addition to or that include application 606. Software 605 may also comprise firmware or some other form of machine-readable processing instructions executable by processing system 602.

In general, software 605 may, when loaded into processing system 602 and executed, transform a suitable apparatus, system, or device (of which computing system 601 is representative) overall from a general-purpose computing system into a special-purpose computing system customized to facilitate enhanced workflows. Indeed, encoding software 605 on storage system 603 may transform the physical structure of storage system 603. The specific transformation of the physical structure may depend on various factors in different implementations of this description. Examples of such factors may include, but are not limited to, the technology used to implement the storage media of storage system 603 and whether the computer-storage media are characterized as primary or secondary storage, as well as other factors.

For example, if the computer readable storage media are implemented as semiconductor-based memory, software 605 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 607 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 609 is optional and may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 609. In some cases, the input and output devices may be combined in a single device, such as a display capable of displaying images and receiving touch gestures. The aforementioned user input and output devices are well known in the art and need not be discussed at length here.

User interface system 609 may also include associated user interface software executable by processing system 602 in support of the various user input and output devices discussed above. Separately or in conjunction with each other and other hardware and software elements, the user interface software and user interface devices may support a graphical user interface, a natural user interface, or any other type of user interface.

Communication between computing system 601 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some communication protocols that may be used include, but are not limited to, the Internet protocol (IP, IPv4, IPv6, etc.), the transfer control protocol (TCP), and the user datagram protocol (UDP), as well as any other suitable communication protocol, variation, or combination thereof.

In any of the aforementioned examples in which data, content, or any other type of information is exchanged, the exchange of information may occur in accordance with any of a variety of protocols, including FTP (file transfer protocol), HTTP (hypertext transfer protocol), REST (representational state transfer), WebSocket, DOM (Document Object Model), HTML (hypertext markup language), CSS (cascading style sheets), HTML5, XML (extensible markup language), JavaScript, JSON (JavaScript Object Notation), and AJAX (Asynchronous JavaScript and XML), as well as any other suitable protocol, variation, or combination thereof.

Among other examples, the present disclosure presents systems comprising at least one processor; and memory encoding computer executable instructions that, when executed by the at least one processor, perform a method for creating a workflow, the method comprising: rendering a file repository within a file sharing tool, wherein the file repository includes at least a workflow board; in response to receiving an input corresponding to the workflow board, displaying a workflow board view as the workflow board within the file repository, wherein the workflow board view comprises a first column including at least one file and a workflow stage control; and in response to receiving an input corresponding to the first column, creating a first stage of the workflow. In further examples, in response to receiving a selection of the workflow stage control, updating the workflow board view displayed as the workflow board to display a second column. In further examples, the method further comprises in response to receiving an input corresponding the second column, creating a second stage of the workflow. In further examples, the input corresponding to the workflow board comprises a drag and drop gesture. In further examples, the input corresponding to the first column comprises a keyboard input for defining the first stage of the workflow. In further examples, the input corresponding to the second column comprises a keyboard input for defining the second stage of the workflow. In further examples, the method further comprises in response to receiving another selection of the workflow stage control, updating the workflow board view displayed as the workflow board to display a third column. In further examples, the method further comprises in response to receiving an input corresponding the third column, creating a third stage of the workflow. In further examples, the first stage, second stage, and third stage of the workflow represent a file status.

Further aspects disclosed herein provide an exemplary method for progressing one or more files through a workflow, the method comprising: displaying a workflow board view within a file repository, wherein the workflow board view comprises at least a first column and a second column, wherein the first column includes at least one file; in response to receiving a drag and drop gesture corresponding to the at least one file, moving the at least one file from the first column to the second column; and in response to moving the at least one file from the first column to the second column, changing a first file status of the at least one file to a second file status of the at least one file. In further examples, the first column represents a first stage of the workflow and the first stage of the workflow represents the first file status, and wherein the second column represents a second stage of the workflow and the second stage of the workflow represents the second file status. In further examples, the method further comprises in response to moving the at least one file from the first column to the second column, initiating the workflow. In further examples, the workflow board view further comprises a third column. In further examples, the method further comprises in response to receiving a drag and drop gesture corresponding to the at least one file, moving the at least one file from the second column to the third column; and in response to moving the at least one file from the second column to the third column, progressing the workflow by changing the second file status of the at least one file to a third file status. In further examples, the third column represents a third stage of the workflow, and the third stage of the workflow represents the third file status. In further examples, the workflow board view further comprises a final column, and further comprising in response to moving the at least one file to the final column, completing the workflow.

Additional aspects disclosed herein provide exemplary systems comprising: one or more computer readable storage media; and program instructions stored on the one or more computer readable storage media that, when executed by at least one processor, cause the at least one processor to at least: initiate rendering of a file repository within a file sharing tool, wherein the file repository includes at least a workflow board; generate a workflow board view associated with a workflow comprising one or more stages; and display the generated workflow board view as the workflow board, wherein the workflow board view comprises a visual representation of a file status of one or more files progressing through the one or more stages of the workflow. In further examples, the workflow board view includes a plurality of columns, wherein each column of the plurality of columns represents a stage of the one or more stages of the workflow. In further examples, the one or more stages of the workflow represent the file status of the one or more files progressing through the one or more stages of the workflow. In further examples, the workflow board view further includes a workflow stage control for creating one or more stages of the workflow.

Techniques for creating, building, and/or utilizing workflows are described. Although aspects are described in language specific to structural features and/or methodological acts, it is to be understood that the aspects defined in the appended claims are not necessarily limited to the specific features or acts described above. Rather, the specific features and acts are disclosed as example forms of implementing the claimed aspects.

A number of methods may be implemented to perform the techniques discussed herein. Aspects of the methods may be implemented in hardware, firmware, or software, or a combination thereof. The methods are shown as a set of blocks that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods may be implemented via interaction between various entities discussed above with reference to the touchable user interface.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an aspect with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

Additionally, while the aspects may be described in the general context of file sharing tools that execute in conjunction with a workflow program that runs on an operating system on a computing device, those skilled in the art will recognize that aspects may also be implemented in combination with other program modules. In further aspects, the aspects disclosed herein may be implemented in hardware.

Generally, program modules include routines, programs, components, data structures, and other types of structures that perform particular tasks or implement particular abstract data types. Moreover, those skilled in the art will appreciate that aspects may be practiced with other computer system configurations, including hand-held devices, multiprocessor systems, microprocessor-based or programmable consumer electronics, minicomputers, mainframe computers, and comparable computing devices. Aspects may also be practiced in distributed computing environments where tasks are performed by remote processing devices that are linked through a communications network. In a distributed computing environment, program modules may be located in both local and remote memory storage devices.

Aspects may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or compact servers, an application executed on a single computing device, and comparable systems.

What is claimed is:

1. A system comprising:
at least one processor; and
memory encoding computer executable instructions that, when executed by the at least one processor, perform a method for creating a workflow, the method comprising:
rendering a file repository within a file sharing tool, wherein the file repository includes at least a workflow board;
in response to receiving an input corresponding to the workflow board, displaying a workflow board view as the workflow board within the file repository, wherein the workflow board view comprises a first column including at least one file and a workflow stage control; and
in response to receiving an input corresponding to the first column, creating a first stage of the workflow.

2. The system of claim 1, the method further comprising in response to receiving a selection of the workflow stage control, updating the workflow board view displayed as the workflow board to display a second column.

3. The system of claim 2, the method further comprising in response to receiving an input corresponding the second column, creating a second stage of the workflow.

4. The system of claim 1, wherein the input corresponding to the workflow board comprises a drag and drop gesture.

5. The system of claim 1, wherein the input corresponding to the first column comprises a keyboard input for defining the first stage of the workflow.

6. The system of claim 3, wherein the input corresponding to the second column comprises a keyboard input for defining the second stage of the workflow.

7. The system of claim 3, the method further comprising in response to receiving another selection of the workflow stage control, updating the workflow board view displayed as the workflow board to display a third column.

8. The system of claim 7, the method further comprising in response to receiving an input corresponding the third column, creating a third stage of the workflow.

9. The system of claim 8, wherein the first stage, second stage, and third stage of the workflow represent a file status.

10. A computer-implemented method for progressing one or more files through a workflow, the method comprising:
displaying a workflow board view within a file repository, wherein the workflow board view comprises at least a first column and a second column, wherein the first column includes at least one file;
in response to receiving a drag and drop gesture corresponding to the at least one file, moving the at least one file from the first column to the second column; and
in response to moving the at least one file from the first column to the second column, changing a first file status of the at least one file to a second file status of the at least one file.

11. The computer-implemented method of claim 10, wherein the first column represents a first stage of the workflow and the first stage of the workflow represents the first file status, and wherein the second column represents a second stage of the workflow and the second stage of the workflow represents the second file status.

12. The computer-implemented method of claim 10, further comprising in response to moving the at least one file from the first column to the second column, initiating the workflow.

13. The computer-implemented method of claim 10, wherein the workflow board view further comprises a third column.

14. The computer-implemented method of claim 13, further comprising:
in response to receiving a drag and drop gesture corresponding to the at least one file, moving the at least one file from the second column to the third column; and
in response to moving the at least one file from the second column to the third column, progressing the workflow by changing the second file status of the at least one file to a third file status.

15. The computer-implemented method of claim 14, wherein the third column represents a third stage of the workflow, and the third stage of the workflow represents the third file status.

16. The computer-implemented method of claim 14, wherein the workflow board view further comprises a final column, and further comprising in response to moving the at least one file to the final column, completing the workflow.

17. A system comprising:
one or more computer readable storage media; and
program instructions stored on the one or more computer readable storage media that, when executed by at least one processor, cause the at least one processor to at least:
initiate rendering of a file repository within a file sharing tool, wherein the file repository includes at least a workflow board;
generate a workflow board view associated with a workflow comprising one or more stages; and
display the generated workflow board view as the workflow board, wherein the workflow board view comprises a visual representation of a file status of one or more files progressing through the one or more stages of the workflow.

18. The system of claim 17, wherein the workflow board view includes a plurality of columns, wherein each column of the plurality of columns represents a stage of the one or more stages of the workflow.

19. The system of claim 17, wherein the one or more stages of the workflow represent the file status of the one or more files progressing through the one or more stages of the workflow.

20. The system of claim 17, wherein the workflow board view further includes a workflow stage control for creating one or more stages of the workflow.
